(19) United States
(12) Patent Application Publication
(10) Pub. No.: US 2026/0301732 A1
(43) Pub. Date: Oct. 1, 2026

(54) METHOD, SYSTEM AND COMPUTER PROGRAM PRODUCT FOR GENERATING TRAINING DATA FOR SPEECH EMOTION RECOGNITION MODEL

(71) Applicant: National Tsing Hua University, Hsinchu (TW)

(72) Inventors: CHI-CHUN LEE, Hsinchu (TW); Bo-Hao Su, Hsinchu (TW)

(21) Appl. No.: 19/313,734

(22) Filed: Aug. 28, 2025

(30) Foreign Application Priority Data
Mar. 31, 2025 (TW) 114112339

(51) Int. Cl. G10L 15/06; G10L 13/08; G10L 25/63

(52) U.S. Cl. CPC G10L 15/063; G10L 13/08; G10L 25/63

(57) ABSTRACT

A method for generating training data for speech emotional recognition (SER) models is provided. The method includes: receiving prompt data, the prompt data including dialogue scenario description information, dialogue participant information, and at least one of a script content and an instruction for automatically generating a script; generating textual dialogue data based on the prompt data by utilizing a large language model, the textual dialogue data including at least one utterance and an emotion label corresponding to each utterance; and converting the textual dialogue data into emotional speech dialogue data by utilizing at least one speech model. In addition, a system and a non-transitory computer-readable medium using this method are also provided.

### CROSS-REFERENCE TO RELATED APPLICATION(S)

The present disclosure claims the benefit of and priority to Taiwan Patent Application No. 114,112,339, filed on Mar. 31, 2025, the contents of which are hereby fully incorporated herein by reference for all purposes.

### FIELD

The present disclosure is generally related to generating training data for speech emotion recognition model, and more specifically, to a method, system and computer program product for generating training data for speech emotion recognition model.

### BACKGROUND

Speech Emotion Recognition (SER) technology refers to the technique of identifying a speaker's emotional state by analyzing acoustic features contained in speech signals. In recent years, with the rapid development of artificial intelligence technology, SER has demonstrated significant value in various application scenarios.

However, with the increasing awareness of personal privacy protection, obtaining authentic emotional speech data has become increasingly difficult. Many high-quality speech data cannot be used for model training due to privacy concerns, especially emotional speech data in sensitive contexts such as medical consultations and personal calls. At the same time, significant domain mismatches exist between different application areas, making it difficult for models trained in one domain to be directly applied to another domain. Traditional methods usually require at least some data from the target domain for adaptive training, which is not only costly in practical applications but sometimes even impossible to implement due to privacy regulation restrictions. Therefore, there is a need for a method that can automatically generate large amounts of high-quality, diverse speech data with accurate emotion label.

### SUMMARY

In view of the above, the present disclosure provides a method, system, and computer program product for generating training data for speech emotional recognition models. This technology automatically generates diverse textual dialogue data with emotion label and emotional speech dialogue data, effectively solving the problem of difficulty in acquiring high-quality data for speech emotional recognition model training.

A first aspect of the present disclosure provides a method for generating training data for speech emotional recognition (SER) models. The method includes: receiving prompt data, the prompt data including dialogue scenario description information, dialogue participant information, and at least one of a script content and an instruction for automatically generating a script; generating textual dialogue data based on the prompt data by utilizing a large language model, the textual dialogue data including at least one utterance and an emotion label corresponding to each utterance; and converting the textual dialogue data into emotional speech dialogue data by utilizing at least one speech model.

In some implementations of the first aspect, the prompt data further includes dialogue content distribution features.

In some implementations of the first aspect, the emotion label includes one of happy, neutral, sad, frustrated, angry, surprise, fear, disgust, and contempt.

In some implementations of the first aspect, converting the textual dialogue data into the emotional speech dialogue data by utilizing the at least one speech model includes: utilizing a first speech model to convert the textual dialogue data into non-emotional speech dialogue data; and utilizing a second speech model to convert the non-emotional speech dialogue data into the emotional speech dialogue data cased on the emotion label in the textual dialogue data.

A second aspect of the present disclosure provides a system for generating training data for speech emotional recognition (SER) models. The system includes: a memory configured to store at least one instruction; and a processor coupled to the memory. When the processor executes the at least one instruction, the processor is configured to: receive prompt data, the prompt data including dialogue scenario description information, dialogue participant information, and at least one of a script content and an instruction for automatically generating a script; generate textual dialogue data based on the prompt data by utilizing a large language model, the textual dialogue data including at least one utterance and an emotion label corresponding to each utterance; and convert the textual dialogue data into emotional speech dialogue data by utilizing at least one speech model.

In some implementations of the second aspect, the prompt data further includes dialogue content distribution features.

In some implementations of the second aspect, the emotion label includes one of happy, neutral, sad, frustrated, angry, surprise, fear, disgust, and contempt.

In some implementations of the second aspect, converting the textual dialogue data into the emotional speech dialogue data by utilizing at least one speech model includes: utilizing a first speech model to convert the textual dialogue data into non-emotional speech dialogue data; and utilizing a second speech model to convert the non-emotional speech dialogue data into the emotional speech dialogue data based on the emotion label in the textual dialogue data.

A third aspect of the present disclosure provides a non-transitory computer-readable medium including at least one instruction. When the at least one instruction is executed by a processor of an electronic device, the electronic device is configured to perform the method according to the first aspect of the present disclosure.

### BRIEF DESCRIPTION OF THE DRAWINGS

FIG. 1 is a diagram of a method for generating training data for speech emotional recognition model in accordance with an example implementation of the present disclosure.

FIG. 2 is a flowchart of a method for generating training data for speech emotional recognition model in accordance with an example implementation of the present disclosure.

FIG. 3 is a block diagram of a computing system in accordance with an example implementation of the present disclosure.

### DESCRIPTION

The following will refer to the relevant drawings to describe implementations of a method and system for implementing a speech emotional recognition training data generation in the present disclosure, in which the same components will be identified by the same reference symbols.

The following description includes specific information regarding the exemplary implementations of the present disclosure. The accompanying detailed description and drawings of the present disclosure are intended to illustrate the exemplary implementations only. However, the present disclosure is not limited to these exemplary implementations. Those skilled in the art will appreciate that various modifications and alternative implementations of the present disclosure are possible. In addition, the drawings and examples in the present disclosure are generally not drawn to scale and do not correspond to actual relative sizes.

The term “couple” is defined as a connection, whether direct or indirect, through an intermediate component, and is not necessarily limited to a physical connection. When the terms “comprising” or “including” are used, they mean “including but not limited to,” and explicitly indicate an open relationship between the combination, group, series, and the like.

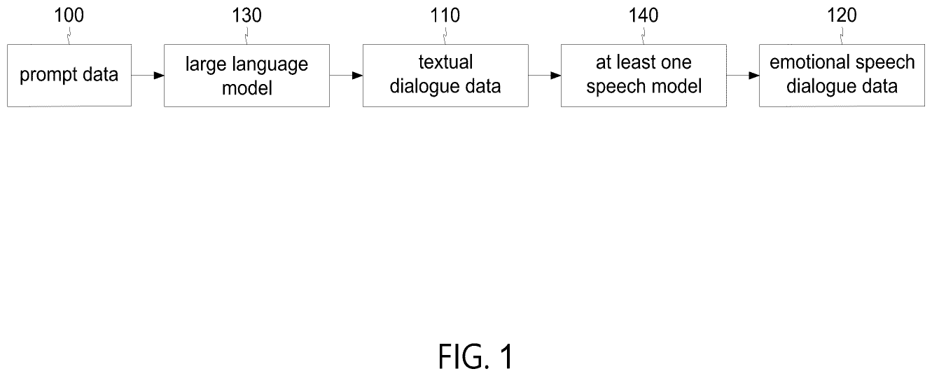

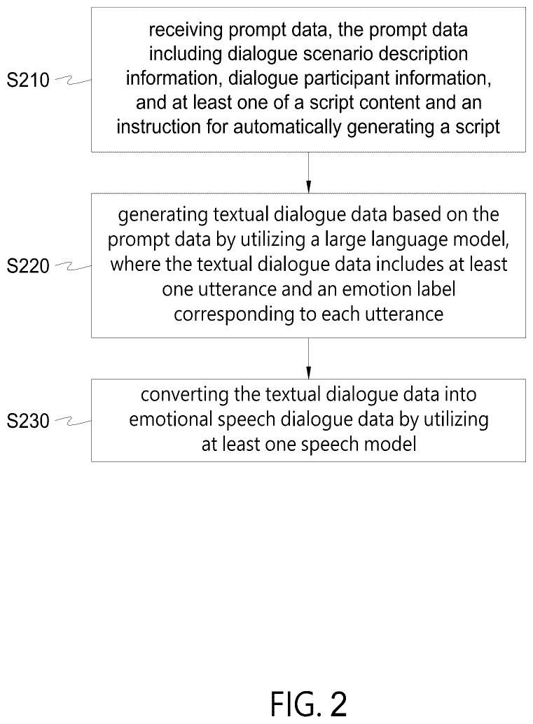

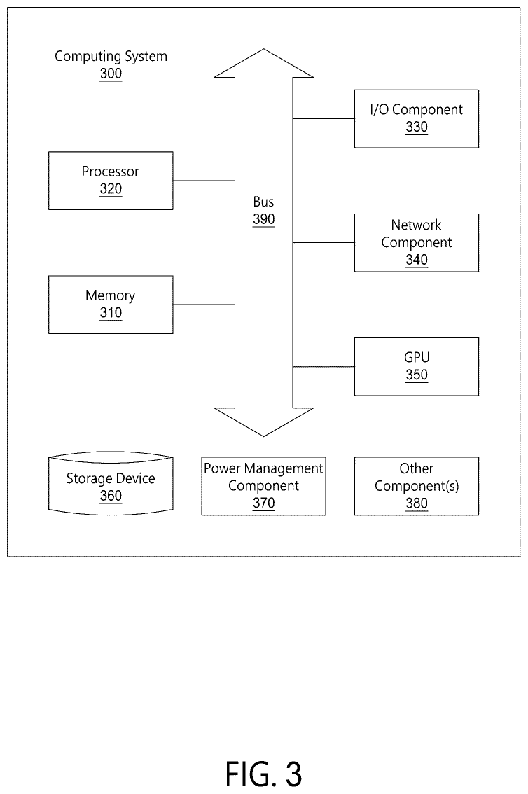

FIG. 1 is a diagram of a method for generating training data for speech emotional recognition model in accordance with an example implementation of the present disclosure. FIG. 2 is a flowchart of a method for generating training data for speech emotional recognition model in accordance with an example implementation of the present disclosure. FIG. 3 is a block diagram of a computing system in accordance with an example implementation of the present disclosure.

Referring to FIG. 1, FIG. 2, and FIG. 3, the method for generating training data for speech emotional recognition models includes receiving prompt data 100 (action S210), generating textual dialogue data 110 by utilizing a large language model 130 (action S220), and converting the textual dialogue data 110 into emotional speech dialogue data 120 by utilizing at least one speech model 140 (action S230). These three main actions constitute the core process of the present disclosure, producing high-quality emotional speech training data in an automated manner. Specifically, the speech emotional recognition model training data generation system (hereinafter referred to as the system) includes the large language model 130 and at least one speech model 140. In some implementations, the large language model 130 and at least one speech model 140 may be implemented in the computing system 300 or stored in the memory 310, the present disclosure is not limited thereto. In some implementations, the system may be implemented by one or more computing systems 300.

Referring to FIG. 2, in action S210, the system receives prompt data 100, the prompt data 100 includes dialogue scenario description information, dialogue participant information, the prompt data 100 further includes at least one of script content and instructions for automatically generating a script, for guiding the large language model 130 to generate textual dialogue data 110. The components of the prompt data 100 are described in detail below.

First, the prompt data 100 includes dialogue scenario description information. The dialogue scenario description information is configured to describe the environment, time background and/or thematic context of the dialogue. Specifically, the dialogue scenario description information includes descriptions of environments such as home, office, hospital, school, restaurant, or phone call, and/or descriptions of thematic contexts such as daily conversation, broadcast content, or customer service calls, the present disclosure is not limited thereto. The dialogue scenario description information may extract attributes from published target documents/papers, rebuilding scene features without directly acquiring the original data. For example, the dialogue scenario description information may be “online customer service department of an electronics retailer, Monday morning during busy hours.” Advantageously, clear scene descriptions provide the basic contextual framework for dialogues, helping to generate authentic dialogue content that conforms to specific situations.

For example, the dialogue scenario description information may be “customer service call.” In some implementations, the specific context in a customer service call may be further described, such as “in the online customer service department of an electronics retailer, the customer encounters issues with activating functions on a newly purchased phone.” This detailed description is limited to the background and topic of the scene, without including dialogue content or specific character attributes, which may guide the large language model 130 to generate dialogue content that better conforms to specific situations.

For example, the dialogue scenario description information may be “hospital.” In some implementations, the hospital scenario may be further described as “in a busy cardiac clinic of a large hospital, during the initial consultation process.” Advantageously, such descriptions of environment and context focus on providing the background of the dialogue, helping to generate professional dialogues related to the medical field, enriching the professionalism and applicability of the training data.

Second, the prompt data 100 includes dialogue participant information. The dialogue participant information is configured to describe the character features, gender, professional background and/or number of participants in the dialogue. For example, the dialogue participant information may be “female” and “male.” In some implementations, the dialogue participant information may be “female, customer service representative,” “male, customer.” In some implementations, the dialogue participant information may be “28-year-old female, electronics customer service representative with 3 years of work experience” and “42-year-old male, first-time smartphone buyer.” Advantageously, clear participant information helps generate dialogue content that conforms to specific character features, making the generated speech emotions closer to real situations, enhancing the representativeness of the training data.

Next, the prompt data 100 further includes at least one of script content and instructions for automatically generating a script. The script content refers to pre-written dialogue text frameworks or fragments for the large language model 130 to reference (and expand), characterized by including directly usable dialogue text; while instructions for automatically generating a script provide creative directions and constraints to the large language model 130, not including actual dialogue content, but rather explanations or requirements guiding the model to create new content. In detail, instructions for automatically generating a script typically include keywords such as “generate”, “create”, or “produce” to explicitly instruct the model to automatically generate content.

To distinguish the scope of various types of prompt data 100, the components of the prompt data 100 are further explained through implementations below. Specifically, dialogue scenario description information mainly describes the environment, background, or topic of the dialogue, such as “in a busy hospital emergency room” or “about customer service issues for purchasing a new phone”. Dialogue participant information clearly specifies the characters in the dialogue and their features, such as “45-year-old female, cardiologist” and “65-year-old female, first-time cardiac patient”. Script content may be pre-written dialogue fragments, such as “Doctor: Hello, what discomfort are you experiencing today? Patient: I've been feeling chest pain recently”. Instructions for automatically generating a script give creative direction to the model, such as “Please generate an interactive dyadic dialogue between a doctor and patient, showing the doctor's professional attitude and patience, as well as the patient's emotional change from nervous to relaxed”.

In some implementations, instructions for automatically generating a script may also include emotion instructions, configured to guide the large language model 130 in assigning specific emotional states or emotional transitions when generating textual dialogue data 110. For example, the instructions for automatically generating a script may adopt the format of “(emotion type) dialogue content description,” where “emotion type” clearly marks the emotion that should be presented in that section of dialogue. For example, instructions for automatically generating a script may be “(Happy) The subject is telling his/her friend that he/she is getting married. (Happy) The subject is very happy and wants to know all the details of the proposal.”, where “(Happy)” indicates that the corresponding dialogue content should present a happy emotion. Advantageously, such emotion instructions enable the large language model 130 to more accurately generate dialogue content with target emotions, enhancing the emotional expression capability of the generated textual dialogue data 110, further improving the quality of the subsequently generated emotional speech dialogue data 120.

The differences and applications of script content and instructions for automatically generating a script are explained through implementations below. Specifically, besides the required dialogue scenario description information and dialogue participant information, the prompt data 100 may selectively include at least one of script content and instructions for automatically generating a script. In some implementations, when the prompt data 100 includes script content without instructions for automatically generating a script, for example, “Scene: electronics customer service center; Participants: female customer service representative, male customer; Script content: Customer: Hello, my recently purchased smartphone cannot connect to WiFi. Customer service: Hello, I'm sorry to hear about this situation, have you tried restarting your phone?”, the system expands based on the provided scene, participant information, and script content, without needing additional generation instructions. In some implementations, when the prompt data 100 includes instructions for automatically generating a script without script content, for example, “Scene: electronics customer service center; Participants: female customer service representative, male customer; Instructions for automatically generating a script: Please generate a complete dialogue where the customer's emotion gradually changes from confusion to understanding, in which the customer service representative guides the customer to solve the WiFi connection problem step by step”, the system may create dialogue content from scratch based on the provided scene and participant information according to the instructions, without relying on any preset dialogue. Advantageously, this flexible combination allows the system to adjust generation strategies according to different application requirements, ensuring both the basic structure and direction of the generated content while increasing creativity and diversity.

In some implementations, the system provides structured prompt templates, where different types of prompt information are completely separated visually and functionally. For example, the prompt template may include clearly marked independent fields, where the “Scene description:” field is configured for inputting dialogue environment and/or background information, the “Participant information:” field is configured for inputting dialogue character features, the “Instructions for automatically generating a script:” field is configured for inputting instructions guiding the model to create content, and the “Preset script:” field is configured for inputting pre-written dialogue fragments. Users may fill in these fields according to their needs. For example, “Scene description: hospital cardiology clinic; Participant information: female cardiologist, female patient visiting for the first time; Instructions for automatically generating a script: Please generate a doctor-patient dialogue showing the patient's emotional change from worry to reassurance; Preset script: Doctor: What discomfort are you experiencing today?”. After receiving this clearly separated structured prompt, the system may accurately identify the boundaries of various types of information, improving the accuracy and specificity of the generated results. The processor 320 may provide more accurate guidance to the large language model 130 based on these structured prompt data 100, making the generated textual dialogue data 110 more aligned with the user's expectations.

In some implementations, the processor 320 may execute a prompt data 100 parsing algorithm, converting free-format prompt data 100 into structured prompt data 100, and clearly identifying the type of each prompt data 100. For example, when a user inputs a natural language prompt like “Please generate a dialogue between a female doctor and a female patient in a hospital cardiology department, with the patient changing from worried to reassured”, the processor 320 may, through natural language processing technology, classify and label different types of prompt data 100, identifying the scene as “hospital cardiology department”, participants as “female doctor and female patient”, and instructions for automatically generating a script as “generate dialogue, patient from worried to reassured”. Advantageously, this automatic classification capability makes the system more user-friendly, allowing users to provide prompt data 100 in a more natural way, while maintaining clear boundaries between various types of information.

In some implementations, the prompt data 100 further includes dialogue content distribution features, configured to guide the large language model 130 to generate textual dialogue data 110 with specific statistical characteristics. Specifically, the dialogue content distribution features may include statistical indicators such as the distribution ratio of various emotion types, the speaking ratio of each character, dialogue length distribution, average duration of utterances, or average word count, the present disclosure is not limited thereto. For example, the dialogue content distribution features may specify “the average word count for each utterance is 15 words”, or “the overall average duration of the dialogue should be 3 minutes”. Advantageously, by specifying these distribution features, training data that better conforms to actual application scenarios may be generated, enabling the model to better adapt to different practical application environments.

In some implementations, the system receives prompt data 100 input by users through the input/output component 330, and automatically executes the emotional speech data generation process through the collaborative operation of the processor 320 and memory 310.

In some implementations, the prompt data 100 may be received in JSON (JavaScript Object Notation) format via the network component 340 and stored in the memory 310, where dialogue scenario description information, dialogue participant information, script content, and instructions for automatically generating a script correspond to different top-level fields in the JSON structure. For example, “{“scene”: “hospital cardiology clinic”, “participants”: “female doctor, female patient”, “script_instruction”: “generate a dialogue that gradually transitions from tension to relaxation”, “script_template”: “Doctor: Hello, what discomfort are you experiencing today?”}”. Each top-level field (scene, participants, script_instruction, script_template) corresponds to different types of prompt information. This structure is beneficial for avoiding confusion between different types of information.

In some implementations, the system may provide a graphical user interface. The graphical user interface may include multiple structured input fields, facilitating user input of various types of prompt data.

In some implementations, users may upload configuration files containing prompt data 100, and the system may parse the configuration file and extract relevant information, improving the efficiency and flexibility of prompt data 100 creation. For example, the configuration file uploaded by users may be in JSON format, such as: “{“scene”: “hospital cardiology clinic”, “participants”: “male doctor, female patient”, “script_instruction”: “generate a dialogue that gradually transitions from tension to relaxation”, “distribution”: “dialogue duration about 3 minutes, average utterance length 15 words, doctor-patient speaking ratio approximately 4:6”}”, the system may parse this JSON file into corresponding prompt data 100. In some implementations, the configuration file uploaded by users may also be in XML format or YAML format, the present disclosure is not limited thereto.

Returning to FIG. 1 and FIG. 2, in action S220, the system generates textual dialogue data 110 based on the prompt data 100 by utilizing a large language model 130. The textual dialogue data 110 includes at least one utterance and an emotion label corresponding to each utterance.

Specifically, the textual dialogue data 110 is a series of utterances generated by the large language model 130 according to the instructions of the prompt data 100. Each utterance corresponds to an emotion label. In some implementations, these utterances form a complete dialogue content. These utterances demonstrate interactions and emotional changes between different characters. In some implementations, the textual dialogue data 110 may be stored in the storage device 360 in JSON or XML (Extensible Markup Language) format. This storage format facilitates subsequent processing and analysis by the system.

In detail, the large language model 130 is a natural language processing model trained on large-scale text data. The large language model 130 is configured to process prompt data 100 and generate dialogue content that conforms to specific situations according to the requirements of the prompt data 100. The large language model 130 undergoes pre-training on large-scale text data. The large language model 130 possesses powerful natural language understanding and generation capabilities. The large language model 130 is configured to generate dialogue content that meets scene requirements and expresses emotions naturally based on the prompt data 100. Advantageously, using this type of pre-trained model for dialogue sound generation not only reduces the cost of data collection and annotation, but also may generate high-quality training data in situations where target domain data is lacking, such as in zero-shot scenarios. This approach effectively solves the problems of cross-corpus domain mismatch and difficulty in data acquisition.

In some implementations, the process of the large language model 130 generating textual dialogue data 110 may be represented as:

$$LLM ( {T}_{gen} , {Emo}_{gen} \vert Prompt , {θ}_{L M} )$$

where T_{gen} represents the utterance content in the generated textual dialogue data 110. Emo_{gen} represents the generated emotion labels. Prompt represents the prompt data 100. θ_{LM} represents the parameters of the large language model 130. This representation describes how the large language model 130 generates utterance content and corresponding emotion labels based on the prompt data 100. The large language model 130 forms complete textual dialogue data 110 through this process.

In some implementations, the large language model 130 may be Llama3-8b, Gemma2-9b, or Llama3-1-8b, the present disclosure is not limited thereto.

In some implementations, the system may adjust the generation strategy of the large language model 130 based on the presence or absence of different components in the prompt data 100. For example, when the prompt data 100 includes dialogue scenario description information, dialogue participant information, and script content without instructions for automatically generating a script, the system may adopt a continuation mode. The continuation mode allows the large language model 130 to expand based on maintaining the existing script style and context. In some implementations, when the prompt data 100 includes dialogue scenario description information, dialogue participant information, and instructions for automatically generating a script without script content, the system may adopt a creative mode. The creative mode allows the large language model 130 to generate complete dialogue content according to the instructions. In some implementations, when dialogue scenario description information, dialogue participant information, script content, and instructions for automatically generating a script are all present, the system may adopt a guided expansion mode. The guided expansion mode allows the large language model 130 to perform targeted expansion in the direction of instructions based on the existing script. This adaptive generation strategy based on prompt data 100 composition maximizes the use of various prompt information. This approach improves the quality and diversity of the generated textual dialogue data 110.

In some implementations, each utterance includes dialogue participant information and utterance content. For example, “M:” represents male, or “F:” represents female. In some implementations, the emotion label is marked at the end or front of the utterance. In some implementations, the emotion label is surrounded by square brackets “[ ]”.

For example, when the prompt data includes dialogue scenario description information “wedding proposal announcement”, dialogue participant information “male friend, female friend”, and instructions for automatically generating a script “(Happy) The subject is telling his friend that he is getting married. (Happy) The subject is very happy and wants to know all the details of the proposal. She also wants to know the date of the wedding.”, the large language model 130 may generate the following textual dialogue data 110:

“M: Oh my god, I have some amazing news to share with you! [Happy]
F: What is it ?! I’m dying to know! [Happy]
M: You won’t believe it . . . I just proposed to Emily, and she said yes! [Happy]
F: AHHH THAT’S AMAZING !!! Congratulations !! When did this happen?
Tell me everything! [Happy]”.

Advantageously, this format makes the emotion label of each utterance clear and easy to identify. This format facilitates the subsequent generation of speech with corresponding emotions based on emotion labels.

In some implementations, the emotion label may include basic emotion types such as happy, neutral, sad, frustrated, angry, surprise, fear, disgust, and contempt. These emotion labels cover the basic categories of human emotions and are capable of capturing various emotional expressions in daily conversations. Advantageously, rich and diverse emotion labels provide more comprehensive emotional training data. The comprehensive data enables speech emotional recognition models to identify and distinguish more subtle emotional changes.

In other implementations, the emotion label may include emotion intensity values configured to express the strength of emotions. For example, “[Happy: 0.8]” may be used to represent a stronger happy emotion, or “[Angry: 0.3]” to represent a slight angry emotion. This representation method allows for more precise description and control of emotions. Advantageously, the introduction of emotion intensity values makes emotional expression more three-dimensional and multi-layered. This approach helps generate more natural and richer emotional speech, thereby improving the training effect of speech emotional recognition models.

Specifically, the utterance content in the textual dialogue data 110 matches the scene, topic, and character features specified in the prompt data 100. For example, in a medical consultation scenario, the utterance content may include professional medical terminology and symptom descriptions; in a customer service scenario, the utterance content may involve product usage problems and solutions. Additionally, the length, complexity, and language style of utterances may also vary according to character features. For example, a doctor's speech may be more professional and formal, while a patient's speech may be more colloquial and emotional. Advantageously, this diversity and specificity in content allows the generated training data to better reflect speech emotional features in real-world scenarios. This approach improves the practicality and generalization ability of the model.

Returning to FIG. 1 and FIG. 2, in action S230, the system converts the textual dialogue data 110 into emotional speech dialogue data 120 by utilizing at least one speech model 140. Specifically, at least one speech model 140 converts each utterance in the textual dialogue data 110 into a corresponding speech segment. At least one speech model 140 imparts corresponding emotional characteristics to the speech according to the emotion label. In detail, the emotional speech dialogue data 120 refers to a series of speech segments generated by at least one speech model 140 based on the textual dialogue data 110. Each speech segment may correspond to the utterance and emotion label in the textual dialogue data 110. These speech segments may contain corresponding prosodic features and acoustic features, such as pitch changes, tones, speech rate, volume, etc. These features effectively convey different types of emotions. Advantageously, this emotional speech dialogue data may be directly used to train speech emotional recognition models without additional annotation work.

In some implementations, at least one speech model 140 may be a single end-to-end speech synthesis model, for example, a VITS model with integrated emotion control mechanism. Advantageously, the end-to-end model simplifies the processing flow. This approach reduces the accumulation of errors in intermediate steps. This simplification helps improve the naturalness of generated speech and the accuracy of emotional expression.

In some implementations, the emotional speech dialogue data 120 may be stored in standard audio formats such as WAV or MP3. These formats facilitate subsequent speech emotional recognition model training and evaluation. The present disclosure is not limited thereto. In some implementations, the system may generate corresponding metadata for each speech segment. This metadata records attributes such as utterance content, emotion label, and speaker information. This information facilitates data management and retrieval.

In some implementations, at least one speech model 140 may include a first speech model and a second speech model. The first speech model converts the textual dialogue data 110 into non-emotional speech dialogue data. Specifically, the first speech model may be a Text-to-Speech (TTS) model (for example, Tacotron series, FastSpeech series, or VITS, the present disclosure is not limited thereto). This type of TTS model does not especially emphasize emotional expression. The first speech model focuses on accurately converting text into clear, fluent neutral speech. For example, the first speech model may convert “I am so happy to see you!” into speech, but this speech may sound relatively neutral, lacking obvious happy emotional expression. Advantageously, this action ensures that the generated basic speech has high-quality acoustic characteristics and clear content expression. This quality provides a good foundation for subsequent emotion injection.

In some implementations, the process of the first speech model converting text to speech may be represented as:

$$VITS ( {X}_{g e n} \vert {T}_{gen} ; {θ}_{T T S} )$$

where X_{gen} represents the generated non-emotional speech dialogue data. T_{gen} represents the utterance content in the textual dialogue data 110. θ_{TTS} represents the parameters of the VITS-TTS model. This representation describes how the VITS-TTS model converts text into neutral speech without emotion. During this process, the VITS-TTS model establishes a preliminary correspondence between utterance content and acoustic features. Through this text-to-speech conversion process, the basic clarity and naturalness of the generated speech may be ensured.

In some implementations, at least one speech model 140 includes a second speech model. The second speech model converts the non-emotional speech dialogue data into emotional speech dialogue data 120 according to the emotion label in the textual dialogue data 110. Specifically, the second speech model may be an Emotion Conversion (EVC) model. The emotion conversion model is configured to adjust the prosodic features of speech to express different emotional states while keeping the speech content unchanged, according to the emotion label. For example, for an utterance labeled as “[Happy]”, the second speech model converts neutral speech into speech with happy emotional features, such as raising pitch, increasing speech rate, and enhancing tonal variations. For example, for an utterance labeled as “[Sad]”, the second speech model may lower pitch, slow down speech rate, and reduce tonal variations. Advantageously, this step-by-step method makes emotional expression more precise and natural. This approach flexibly addresses different types and intensities of emotional needs.

In some implementations, the process of the second speech model injecting emotion into neutral speech may be represented as:

$$VITS ( {X}_{g e n}^{′} \vert {X}_{g e n} ; {Emo}_{g e n} ; {θ}_{V C} )$$

where X′_{gen} represents the final generated emotional speech dialogue data 120. X_{gen} represents the non-emotional speech dialogue data. Emo_{gen} represents the emotion label in the textual dialogue data 110. θ_{VC} represents the parameters of the emotion conversion model. This representation describes how to adjust the prosodic features of speech according to emotion labels while keeping the speech content unchanged. This process achieves accurate emotional expression. This approach enables the model to make fine adjustments for different emotion types and intensities, thus producing more natural speech data with rich emotional expressiveness.

That is, the system inputs the textual dialogue data 110 into the first speech model. The first speech model generates non-emotional speech dialogue data that retains emotion labels. This non-emotional speech dialogue data is provided to the second speech model. Next, the second speech model converts the non-emotional speech dialogue data into emotional speech dialogue data 120 according to these emotion labels. Advantageously, by separating the two stages of speech synthesis and emotion injection, the system may more accurately control the processing of each stage.

Through the above method, the present disclosure provides an efficient automated method for generating training data for speech emotional recognition models. This method utilizes a large language model 130 and at least one speech model 140 to generate a large amount of high-quality, diverse speech dialogue data with accurate emotion labels based on prompt data 100. This method effectively solves the problem of difficulty in acquiring training data for speech emotional recognition models in existing technology. Advantageously, this method not only reduces the cost of data collection and annotation, but also may generate customized training data for specific application scenarios, thus improving model performance in practical applications.

To verify the effectiveness of the method of the present disclosure, a series of experiments were conducted to evaluate the impact of generating training data using prompt data 100 on the performance of speech emotional recognition models. The experimental results show that the training data generated by the large language model 130 using the prompt data 100 designed in the present disclosure effectively enhances model performance in the target domain. This enhancement is especially significant in zero-shot scenarios where target domain data is lacking.

Before conducting experimental verification, the present disclosure first selected two representative target corpora as evaluation benchmarks. The first target corpus is IEMOCAP (Interactive Emotional Dyadic Motion Capture). The IEMOCAP corpus includes 5 conversation sessions. Each session involves interactive dyadic dialogue between one male and one female. This design aims to induce specific emotional responses. The second target corpus is MSP-PODCAST. The MSP-PODCAST corpus consists of natural speech segments extracted from online podcast programs. MSP-PODCAST includes diverse topics, multiple types of speakers, and rich forms of emotional expression. The two corpora represent different methods of acquiring emotional speech and application scenarios. These corpora provide a comprehensive testing environment.

Specifically, the present disclosure adopts a cross-modal evaluation method, evaluating the effectiveness of generated training data in two dimensions: text-only modality and speech-only modality. This separated evaluation strategy comprehensively examines the performance of the method of the present disclosure at different processing stages. Specifically, the text-only modality evaluation directly uses textual dialogue data 110 and its corresponding emotion labels for model training. This text-only modality evaluation builds a classifier through the BERT pre-trained model, followed by a one-dimensional convolutional layer and a classification MLP layer. The speech-only modality evaluation uses the final generated emotional speech dialogue data 120 for model training. This speech-only modality evaluation adopts the SOTA supervised learning model Data2vec to extract features, and builds a classifier through projection layers and classification layers. Advantageously, the cross-modal evaluation method not only verifies the effectiveness of the large language model 130 in generating textual dialogue and emotion labels, but also comprehensively evaluates the performance of the speech model in converting textual emotions into acoustic features. This approach provides more comprehensive and rigorous technical verification. The experimental results show that the method of the present disclosure achieves excellent performance in both modalities, proving the effectiveness and robustness of the entire generation process. The experimental results are presented in Table 1 and Table 2 below.

Referring to Table 1, significant advantages of the method of the present disclosure may be observed based on the experimental data. Specifically, in the IEMOCAP text-only modality experiment, the Unweighted Average Recall (UAR) of models trained with real data shows high variability: MSP-IMPROV (M-I) reaches 38.17%, MELD only reaches 29.95%, MSP-PODCAST (M-P) is 38.86%, with an overall average of 35.66% and a standard deviation of 4.04%. In comparison, models trained with emotional speech dialogue data 120 (Syn. Source) generated by the method of the present disclosure perform better and more stably: Llama3-based reaches 41.97%, Gemma2-based reaches 40.82%, Llama3-1-based reaches 40.34%, with an overall average of 41.04% and a standard deviation of only 0.68%. This result confirms that the training data generated by the present disclosure more precisely captures target domain features.

TABLE 1

| | | Target-IEMOCAP | | | |
|---|---|---|---|---|---|
| | | Text-only | | Speech-only | |
| Training Source | | UAR(%) | WA(%) | UAR(%) | WA(%) |
| Real | M-I | 38.17 | 42.89 | 47.26 | 43.01 |
| Source | MELD | 29.95 | 35.20 | 34.16 | 38.96 |
| | M-P | 38.86 | 43.95 | 46.41 | 50.62 |
| | Avg._{±Std.} | 35.66_{±4.04} | 40.68 | 42.61_{±5.98} | 44.20 |
| Syn. | IEM(Llama3) | 41.97 | 38.73 | 44.82 | 45.85 |
| Source | IEM(Gemma2) | 40.82 | 39.96 | 43.23 | 45.34 |
| | IEM(Llama3-1) | 40.34 | 40.50 | 44.83 | 46.07 |
| | Avg._{±Std.} | 41.04_{±0.68} | 39.73 | 44.29_{±0.75} | 45.75 |

Referring to Table 1, the speech-only modality experiment also shows similar trends. It should be noted that among real data, MSP-IMPROV achieves higher performance (47.26% UAR), while MELD only reaches 34.16% UAR. The difference causing a standard deviation of 5.98% is mainly due to the high similarity between MSP-IMPROV and IEMOCAP in scenario settings and recording environments. This means better performance may be achieved when the source domain and target domain are highly similar. However, in practical applications, it is difficult to ensure that data highly similar to the target domain may be obtained each time. In comparison, models trained with emotional speech dialogue data 120 generated by the method of the present disclosure achieve an average of 44.29% UAR in the speech modality, with a standard deviation of only 0.75%. This performance is not only stable but also approaches or even exceeds the best real data performance.

Referring to Table 2, consistent trends may also be observed in experiments targeting MSP-PODCAST. Specifically, in the text modality, real data has an average performance of 37.78% UAR (standard deviation 1.13%), while emotional speech dialogue data 120 generated by the method of the present disclosure achieves an average of 41.56% UAR (standard deviation 1.14%). That is, the gap in speech modality is more significant: real data averages only 35.26% UAR (standard deviation 2.75%), while emotional speech dialogue data 120 reaches 43.83% UAR (standard deviation only 0.65%). This again confirms the effectiveness and stability of the method of the present disclosure.

TABLE 2

| | | Target-MSP-PODCAST | | | |
|---|---|---|---|---|---|
| | | Text-only | | Speech-only | |
| Training Source | | UAR(%) | WA(%) | UAR(%) | WA(%) |
| Real | M-I | 38.29 | 48.90 | 37.12 | 42.84 |
| Source | MELD | 38.85 | 44.74 | 31.36 | 57.72 |
| | M-P | 36.21 | 43.22 | 37.29 | 38.54 |
| | Avg._{±Std.} | 37.78_{±1.13} | 45.62 | 35.26_{±2.75} | 46.37 |
| Syn. | IEM(Llama3) | 42.47 | 37.80 | 43.04 | 46.99 |
| Source | IEM(Gemma2) | 39.95 | 52.25 | 44.42 | 38.23 |
| | IEM(Llama3-1) | 42.27 | 47.39 | 44.43 | 33.82 |
| | Avg._{±Std.} | 41.56_{±1.14} | 45.81 | 43.83_{±0.65} | 39.68 |

In other words, the above experimental results demonstrate the advantages of the present disclosure. Without relying on source domain data highly similar to the target domain, high-quality training data more closely matching target domain characteristics may be generated through prompt data 100 guiding the large language model 130 and at least one speech model 140. This approach solves the core problem of inconsistency between source domain and target domain in traditional cross-domain SER methods, significantly reducing data acquisition costs and improving model applicability in practical applications. Additionally, the method of the present disclosure does not require obtaining any target domain data or features (zero-shot). Traditional domain adaptation methods such as domain adversarial learning and unsupervised domain adaptation all require obtaining partial target domain data or features, which may be difficult to implement due to privacy issues. The method of the present disclosure only needs to extract target domain description information from publicly available research literature to generate high-quality training data, making SER model training possible in situations completely without target domain data. This characteristic gives the present disclosure greater flexibility and feasibility in practical applications.

FIG. 3 is a block diagram of a computing system in accordance with an example implementation of the present disclosure.

Referring to FIG. 3, computer-implemented methods, such as methods for generating training data for speech emotional recognition model introduced in the present disclosure, as well as other computer-implemented methods, may be implemented on a computing system 300 with various hardware components. Similarly, the system for generating training data for speech emotional recognition (SER) models introduced in the present disclosure is also a computer-implemented method, which may be implemented on a computing system 300 with various hardware components. In some implementations, the computing system 300 may be implemented in the form of an electronic device, which may include, but is not limited to, one or more of the following components: processor (e.g., Central Processing Unit (CPU)) 320, Graphics Processing Unit (GPU) 350, input/output components 330, network components 340, and memory 310. These components may communicate and transfer data via a system bus 390. However, the present disclosure does not limit the specific models, quantities, and configurations of these components. Those skilled in the art may adjust, select, or add/subtract components based on the specific requirements and operating environment when implementing the present disclosure.

In some implementations, the primary computing core inside the computing system 300 is one or more processors 320. The processor 320 may be responsible for running the main computational processes and related control logic of algorithms, such as generating training data for speech emotional recognition models. In some implementations, the processor 320 may be configured to execute processing instructions (e.g., machine/computer-executable instructions) stored in non-volatile computer-readable media (e.g., storage device 360).

In some implementations, the emotional speech dialogue data 120 may be stored in the storage device 360 as a dataset for training speech emotional recognition models.

In some implementations, to improve the computational efficiency of generating training data for speech emotional recognition models, the computing system 300 may also include one or more Graphics Processing Units 350 designed for massive parallel computing. This Graphics Processing Unit 350 may effectively enhance the computational capability of the system when generating training data for speech emotional recognition models and during inference.

In some implementations, the computing system 300 may implement a batch processing mechanism to process multiple sets of prompt data 100 simultaneously, improving the efficiency of generating training data. For example, the processor 320 may utilize parallel computing techniques to initiate multiple threads. Each thread processes one set of prompt data 100. The processor 320 may utilize the Graphics Processing Unit 350 to accelerate the computational processes of the large language model 130 and at least one speech model 140.

In some implementations, the computing system 300 may include various input/output components 330 that are configured to receive user input and display system output. For example, the input/output components 330 may include a keyboard, mouse, touchpad, display screen, speakers, and other types of sensing devices.

In some implementations, the computing system 300 may also include network components 340 configured for network communication. For example, the network components 340 may include a network interface card for wired or wireless network connections, or communication modules for 3G, 4G, 5G, or other wireless communication technologies.

In some implementations, the computing system 300 may include one or more memory components 310, such as volatile memory like Random Access Memory (RAM). The memory 310 may store the parameters for generating training data for speech emotional recognition models, as well as other data and programs that are used to run algorithms, such as generating training data for speech emotional recognition models.

Furthermore, the computing system 300 may also include one or more of the following components: storage devices 360, power management components 370, and other various hardware components 380.

In some implementations, the computing system 300 may include one or more storage devices 360, such as non-volatile memory components like Hard Disk Drive (HDD) or Solid-State Drive (SSD). The storage devices 360 may be configured to store the code for the speech emotional recognition model training data generation system, large language model 130 parameters, speech model 140 parameters, etc. Additionally, storage devices 360 may also be configured to store prompt data 100, textual dialogue data 110, emotional speech dialogue data 120, and other intermediate results and final outputs.

In some implementations, the computing system 300 may include one or more power management components 370, which are configured to provide power to various hardware components of the computing system 300 and manage their power consumption. These power management components 370 may include batteries, power converters, and other power management devices.

In some implementations, the computing system 300 may also include other various hardware components 380, such as cooling fans, heat dissipators, and other various control and monitoring devices. The present disclosure is not limited in this regard.

Another implementation of the present disclosure provides a computer program product, including computer program instructions stored on a computer-readable medium. When a processor of an electronic device executes these computer program instructions, the electronic device performs the aforementioned method for generating training data for speech emotional recognition models. Specifically, the computer program product includes program instructions for receiving prompt data 100, program instructions for generating textual dialogue data 110 by utilizing a large language model 130, and program instructions for converting the textual dialogue data 110 into emotional speech dialogue data 120 by utilizing at least one speech model 140.

In some implementations, the computer program product may be implemented in the form of computer software. This computer software includes a specific set of program instructions. When the processor executes this set of program instructions, the processor performs actions of receiving prompt data 100 (including dialogue scenario description information, dialogue participant information, and at least one of script content and instructions for automatically generating a script), generating textual dialogue data 110 (including at least one utterance and an emotion label corresponding to each utterance) by utilizing a large language model 130, and converting the textual dialogue data 110 into emotional speech dialogue data 120 by utilizing at least one speech model 140.

In some implementations, the system for generating training data for speech emotional recognition models may be implemented by various hardware architectures. Specifically, the system may be viewed as a functional entity composed of the processor 320, memory 310, input/output component 330, storage device 360, and network component 340. This functional entity implements core functionalities such as receiving prompt data 100, generating textual dialogue data 110 by utilizing a large language model 130, and converting the textual dialogue data 110 into emotional speech dialogue data 120 by utilizing at least one speech model 140.

Specifically, the processor 320 is configured to execute program instructions stored in the memory 310. These instructions include: code instructing the processor 320 to receive prompt data 100, where the prompt data 100 includes dialogue scenario description information, dialogue participant information, where the prompt data 100 further includes at least one of script content and instructions for automatically generating a script; code instructing the processor 320 to initiate and control the large language model 130, enabling the large language model 130 to generate textual dialogue data 110 based on the prompt data 100, where the textual dialogue data 110 includes at least one utterance and an emotion label corresponding to each utterance; and code instructing the processor 320 to initiate and control at least one speech model 140, enabling at least one speech model 140 to convert the textual dialogue data 110 into emotional speech dialogue data 120.

In some implementations, when the system adopts an implementation including a first speech model and a second speech model, the system first utilizes the first speech model to convert the textual dialogue data 110 into non-emotional speech dialogue data. Then the system utilizes the second speech model to convert the non-emotional speech dialogue data into emotional speech dialogue data 120 according to the emotion labels in the textual dialogue data 110. This modular audio processing architecture enhances the system's precise control capability in emotional speech synthesis. This architecture enables the system to generate more natural and authentic emotional speech training data.

It should be noted that the system of the present disclosure is a functional entity composed of various hardware components, including the processor 320, memory 310, and input/output component 330. The large language model 130 and at least one speech model 140 are stored in the form of code and parameters in the memory 310 or storage device 360 of the system, and are loaded and executed by the processor 320. That is, the system does not directly include the large language model 130 and at least one speech model 140 as hardware components, but rather calls and runs these models by executing code stored in the memory 310, to implement the aforementioned method actions. It is worth mentioning that the specific technical details of the above system implementation have been elaborated in the description of the method in the former part of this specification. The system implementation of the present disclosure is closely related to the method implementation. The functions of various modules in the system correspond to the actions of the method. For example, the module for receiving prompt data 100 in the system corresponds to action S210, the module for generating textual dialogue data 110 by utilizing a large language model 130 corresponds to action S220, and the module for converting the textual dialogue data 110 into emotional speech dialogue data 120 by utilizing at least one speech model 140 corresponds to action S230. Since the specific implementations of these actions have been described in detail in the former part of this specification, those skilled in the art should understand the specific implementation of the corresponding system, so it will not be repeated here.

In some implementations, the computer-readable medium of the computer program product may be Read-Only Memory (ROM), Random Access Memory (RAM), or other suitable computer-readable storage media. The program instructions included in the computer-readable medium may be loaded and executed by one or more processors 320 to implement various functions of the present disclosure. In some implementations, the computer program product may be made in the form of memory cards, USB flash drives, or other removable storage devices, facilitating transfer and deployment between different electronic devices.

This form of computer program product makes the method of the present disclosure easy to implement on different electronic devices, increasing the application flexibility and promotion value of the present disclosure. Through the form of a computer program product, users only need to install the corresponding program to automatically generate training data for speech emotional recognition models on any electronic device that meets the system requirements. There is no need to redevelop or design the system architecture, greatly reducing the threshold and cost of technical implementation.

Additionally, implementations of the present disclosure may also be implemented as one or more computer program products or one or more non-transitory computer-readable medium, which include one or more instructions of a computer program. Specifically, the computer program (also referred to as a program, software, script, or code) may be presented in any form of programming language and can be deployed in any form. During the operation of the computing system 300 (e.g., electronic device), the instructions or part of them may reside entirely or at least partially inside the processor 320, allowing the processor 320 to execute the methods introduced in the disclosure.

In summary, the method and system for generating training data for speech emotional recognition models provided in the implementation of the present disclosure have the following technical advantages. First, unlike methods requiring a large amount of manual annotation, the present disclosure automatically generates textual dialogue data with emotion labels by guiding a large language model 130 through prompt data 100, thus reducing the cost and difficulty of acquiring high-quality emotional speech data. Second, unlike traditional methods that rely on source domain data highly similar to the target domain, the method of the present disclosure may generate training data that outperforms real data and is more stable in zero-shot scenarios, thus effectively solving the inconsistency problem between source domain and target domain. Finally, the method of the present disclosure has strong scalability, capable of customizing specialized training data for different application scenarios, providing new possibilities for the application of speech emotional recognition technology in various fields.

Based on the above description, it is apparent that various techniques can be configured to implement the concepts described in this application without departing from their scope. Furthermore, although certain implementations have been specifically described and illustrated, those skilled in the art will recognize that variations and modifications can be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions can be made within the scope of the present disclosure.

What is claimed is:

1. A method for generating training data for speech emotional recognition (SER) models, comprising:
receiving prompt data, the prompt data comprising dialogue scenario description information, dialogue participant information, and at least one of a script content and an instruction for automatically generating a script;
generating textual dialogue data based on the prompt data by utilizing a large language model, the textual dialogue data comprising at least one utterance and an emotion label corresponding to each utterance; and
converting the textual dialogue data into emotional speech dialogue data by utilizing at least one speech model.

2. The method of claim 1, wherein the prompt data further comprises dialogue content distribution features.

3. The method of claim 1, wherein the emotion label comprises one of happy, neutral, sad, frustrated, angry, surprise, fear, disgust, and contempt.

4. The method of claim 1, wherein converting the textual dialogue data into the emotional speech dialogue data by utilizing the at least one speech model comprises:
utilizing a first speech model to convert the textual dialogue data into non-emotional speech dialogue data; and
utilizing a second speech model to convert the non-emotional speech dialogue data into the emotional speech dialogue data based on the emotion label in the textual dialogue data.

5. A system for generating training data for speech emotional recognition (SER) models, the system comprising:
a memory configured to store at least one instruction;
a processor coupled to the memory, wherein when the processor executes the at least one instruction, the processor is configured to:
receive prompt data, the prompt data comprising dialogue scenario description information, dialogue participant information, and at least one of a script content and an instruction for automatically generating a script;
generate textual dialogue data based on the prompt data by utilizing a large language model, the textual dialogue data comprising at least one utterance and an emotion label corresponding to each utterance; and
convert the textual dialogue data into emotional speech dialogue data by utilizing at least one speech model.

6. The system of claim 5, wherein the prompt data further comprises dialogue content distribution features.

7. The system of claim 5, wherein the emotion label comprises one of happy, neutral, sad, frustrated, angry, surprise, fear, disgust, and contempt.

8. The system of claim 5, wherein converting the textual dialogue data into the emotional speech dialogue data by utilizing the at least one speech model comprises:
utilizing a first speech model to convert the textual dialogue data into non-emotional speech dialogue data; and
utilizing a second speech model to convert the non-emotional speech dialogue data into the emotional speech dialogue data based on the emotion label in the textual dialogue data.

9. A non-transitory computer-readable medium comprising at least one instruction, wherein when the at least one instruction is executed by a processor of an electronic device, the electronic device is configured to perform the method of claim 1.

10. The non-transitory computer-readable medium of claim 9, wherein when the at least one instruction is executed by the processor of the electronic device, the electronic device is configured to perform the method of claim 2.

11. The non-transitory computer-readable medium of claim 9, wherein when the at least one instruction is executed by the processor of the electronic device, the electronic device is configured to perform the method of claim 3.

12. The non-transitory computer-readable medium of claim 9, wherein when the at least one instruction is executed by the processor of the electronic device, the electronic device is configured to perform the method of claim 4.
